(19) United States
(12) Patent Application Publication
(10) Pub. No.: US 2026/0019093 A1
(43) Pub. Date: Jan. 15, 2026

(54) RF BROADBAND AMPLIFIER STATION WITH DISTRIBUTED CONTROL SYSTEM

(71) Applicant: Broadband International Inc., Medley, FL (US)

(72) Inventors: Dogan Atlas, Atlanta, GA (US); Lai Hoang, Suwanee, GA (US); Alfredo Acosta, Buford, GA (US)

(21) Appl. No.: 19/265,793

(22) Filed: Jul. 10, 2025

Related U.S. Application Data
(60) Provisional application No. 63/669,396, filed on Jul. 10, 2024.

(51) Int. Cl. H04B 1/00; H04B 1/04

(52) U.S. Cl. CPC H04B 1/0078; H04B 1/0458; H04B 2001/0408

(57) ABSTRACT

A broadband signal power amplifier includes a signal input, a signal-level meter (SLM), a microcontroller communicatively coupled to the SLM, a signal output, and a plurality of stages between the signal input and output, wherein each stage includes a variable attenuator module, a variable equalizer module, and an amplifier. The SLM is configured to measure the total composite power (TCP) and the per-channel signal levels (PCLs) of the signal between the first input and first stage, and between the last stage and the output, and provide the measurements to the microcontroller. The microcontroller is configured to adjust the attenuation and equalization of the variable attenuator module and variable equalizer module of each stage, such that the signal remains within a specified carrier to composite noise (CCN) range between the input and the output, and such that the signal has a desired TCP, PCLs, and tilt when passing through the output.

### CROSS-REFERENCE TO RELATED APPLICATION(S)

This application claims the benefit of priority under 35 U.S.C. § 119 (e) to U.S. Provisional Patent Application Ser. No. 63/669,396, filed Jul. 10, 2024. The entire content of this application is hereby incorporated by reference herein.

### BACKGROUND

This invention relates generally to power amplifiers, and more specifically to methods and apparatus for a broadband amplifier with distributive ALSC (Automatic Level and Slope Control).

Cable television (CATV) is a form of broadcasting that transmits programs to paying subscribers through a physical land-based infrastructure of coaxial cables or through a combination of fiber-optic and coaxial cables rather than through the airwaves. Thus, CATV networks provide a direct link from a transmission center, such as a headend, to a plurality of subscribers located at typically addressable remote locations, such as homes and businesses.

Cable television networks based on coaxial distribution have been deployed for over half a century. The main function for early cable systems was to provide television service to areas where off-the-air reception was unavailable. In the past thirty years, most cities and county locations have been wired for cable television services. These services have evolved from 2-12 local off-air channels in the 1950s and 1960s to a variety of current services over a signal distribution service transmitting FM radio broadcasts, multi-channel TV programs, pay-per-view-movies (Video on Demand), information services such as videotext, and the like. Many cable systems now originate their own programming in an ever-increasing number of channels. In recent years, novel services have been made available to the subscribers, including interactive services. One such service regards a two-way, interactive communication involving access to established data communication networks, such as the Internet. CATV transmission, however, has been designed mostly to optimize downstream broadcasting; it was not configured for upstream receipt of information from subscribers. Even though upstream transmission has existed for years, recent advances and customer requirements have increased the kind and amount of upstream transmission to such an extent that the infrastructure for transmitting that upstream information has issues needing to be corrected and/or improved.

The signals that are carried over the coaxial cable delivery system are typically received at a headend facility. A CATV headend is the central transmission center operative to gather and to provide complex audio, visual, and data media throughout a geographical area, which can cover most or all of a small city. In big cities or metropolitan areas, multiple headend facilities cover separate areas but can be interconnected redundantly for reliable supply of signals. The signals at the headend are received through, for example, satellite receiver antennas, antennas erected on a tower, microwave links, fiber-optic cables, and direct coaxial interconnects, and the external signals received through the various types of employed antennas include satellite, microwave, and local TV station broadcasts. Additionally, locally produced and pre-recorded programs can be introduced into the system. The responsibility of the headend is to process and to combine the received signals for distribution to customers and businesses. In addition, the headend assigns a channel frequency to all the signals destined for cable distribution. These single-received signals are multiplexed into a group of channels that are spaced 6 MHz apart, which are then offered to the subscribers selectively or are bundled as packages. Pay-per-view and special pay channels are added by keying the subscribers' set-top boxes or by phone authorization from the subscribers. If an upstream channel is operative in the network, the option of electrical authorization can be provided to the subscribers.

Programming has increased from the local off-the-air channels to include local, regional, national, and international programming. More and more channels have been added over the years so that a typical cable system now might offer hundreds of channels with analog and digitally compressed services. Once the signals have been processed at the headend, they can be distributed to the coaxial system through fiber optic cables, microwave transmitters, or directly from the headend over the coaxial network.

A CATV system comprises a plurality of elements, which are operative in maintaining the flow of electrical data information through a coaxial conductor or through a combination of fiber-optic and coaxial cables to subscribers. The infrastructure of the system is required to span vast urban areas by cables installed underground or on high poles. It is routinely expected that the transmitted signals be kept at their highest possible fidelity having the lowest possible random energy interference level and this ability requires the CATV provider to periodically adjust the signals at each interconnect location.

Coupled between the headend and the subscriber end of the CATV system is a system of cables. A plurality of trunk cables, constructed of large diameter coaxial cables or of a combination of coaxial and fiber-optic cables, carry the signals from the headend to a series of distribution points. A typical cable system architecture includes a main trunk cable that is connected between the headend and these distribution points, referred to as hub stations or trunk/bridger stations. One or more feeder cables feed off the trunk/bridger station. Feeder cables branch out from the trunks and are responsible for serving local neighborhoods. Each feeder cable contains a number of taps disposed along the length of the feeder cable, and each tap contains a number of ports. A drop cable is connected between each port and a subscriber end and forms the familiar coaxial cables that enter directly into a CATV subscriber's premises. Terminal equipment is connected to the drop cable inside a CATV subscriber's home through a wall outlet. Among the more common terminal devices are televisions, VCRs, set-top boxes, converters, de-scramblers, cable modems, and splitters. For a system offering two-way communications, the subscriber end also has a terminal that transmits signals upstream, in the return path of the cable system.

### BRIEF SUMMARY

In an aspect, a broadband signal power amplifier includes a signal input, a signal-level meter (SLM), a microcontroller communicatively coupled to the SLM, a signal output, and a plurality of stages between the signal input and the signal output, wherein each stage includes a variable attenuator module, a variable equalizer module, and an amplifier. The SLM is configured to measure the total composite power (TCP) and the per-channel signal levels (PCLs) of the signal between the first input and a first stage, and between a last stage and the output, and provide the measurements to the microcontroller. The microcontroller is configured to adjust the attenuation and equalization of the variable attenuator module and variable equalizer module of each stage, such that the signal remains within a specified carrier to composite noise (CCN) range between the input and the output, and such that the signal has a desired TCP, PCLs, and tilt when passing through the output.

In an embodiment, the first stage of the broadband signal power amplifier further includes a first set of switches configured to switch a signal pathway between pathway 1 and pathway 2, where pathway 1 includes the variable attenuator module and the variable equalizer module of the first stage, and pathway 2 includes a bypass wire between the first set of switches. The variable equalizer module may comprise a second set of switches configured to switch a circuit between pathway 1A and pathway 1B, where pathway 1A includes a cable-simulation module configured to reduce the tilt of a signal passing through pathway 1A, and pathway 1B includes a cable-equalizer module configured to increase the tilt of a signal passing through pathway 1B.

In various related embodiments, the cable-simulation module may be a variable cable-simulation module, and the cable-equalizer module may be a variable cable-equalizer module. The cable-simulation module may be a fixed cable-simulation module and the cable-equalizer module may be a fixed cable-equalizer module.

In another embodiment, the first stage of the broadband signal power amplifier further includes a first set of switches configured to switch a signal pathway between pathway 1 and pathway 2, where pathway 1 includes the variable attenuator module and the variable equalizer module of the first stage, and pathway 2 includes a bypass wire between the first set of switches. The variable equalizer module may comprise a second set of switches configured to switch a circuit between pathway 1A and pathway 1B, where pathway 1A includes a cable-simulation module configured to reduce the tilt of a signal passing through pathway 1A, and pathway 1B includes bypass wire between the second set of switches.

In various related embodiments, the cable-simulation module may be a variable cable-simulation module, and the cable-equalizer module may be a variable cable-equalizer module. The cable-simulation module may be a fixed cable-simulation module and the cable-equalizer module may be a fixed cable-equalizer module.

In another embodiment, the variable equalizer module of the first stage includes a set of switches configured to switch a circuit between a pathway 1 and a pathway 2, where pathway 1 includes a cable-simulation module configured to reduce the tilt of a signal passing through pathway 1, and where pathway 2 includes a cable-equalizer module configured to increase the tilt of a signal passing through pathway 2.

In a different embodiment, the variable equalizer module of the first stage includes a set of switches configured to switch a circuit between a pathway 1 and a pathway 2, where pathway 1 includes a cable-simulation module configured to reduce the tilt of a signal passing through pathway 1, and where pathway 2 includes a bypass wire between the set of switches.

The broadband signal power amplifier may further include a number of digital potentiometers (DigiPots), each of which is disposed between (i) the variable attenuator module and variable equalizer module of each stage, and (ii) the microcontroller. The amplifier of the first stage may be a push-pull MMIC.

In another aspect, a broadband signal power amplifier includes: a first port; a second port; and a plurality of at least four cascading stages between and coupled to the first port and the second port, which form a path between the first and second ports. Each stage includes, in order along the path between the first port to the second port, a variable equalizer, a variable attenuator, and an amplifier. The broadband signal power amplifier further includes a signal-level meter (SLM) coupled to the first port and the second port, and programmed to measure attributes of an input signal received at the first port and an output signal to be launched from the second port, including input TCP, input tilt, input PCLs, output TCP, output tilt, and output PCLs. The broadband signal power amplifier also includes a microcontroller communicatively coupled with the SLM, and programmed to (a) receive a desired output signal level, a desired output tilt, the input TCP, the input tilt, the input PCLs, the output TCP, the output tilt, and the output PCLs. The microcontroller is also configured to: (b) control the variable attenuator of a first of the plurality of at least four cascading stages to attain nominal total composite power at the output of the amplifier of the first stage; (c) control the variable equalizer of a second of the plurality of at least four cascading stages to attain tilt between about 0 dB and about 5 dB at the output of the amplifier of the first stage; (d) control the variable attenuator of the second of the plurality of at least four cascading stages to attain nominal total composite power at the output of the amplifier of the second stage; (e) control the variable equalizer of a third of the plurality of at least four cascading stages to attain tilt between about 5 dB and about 10 dB at the output of the amplifier of the third stage; (f) control the variable attenuator of the third of the plurality of at least four cascading stages to attain nominal total composite power at the output of the amplifier of the third stage; (g) control the variable attenuator of the fourth of the plurality of at least four cascading stages to attain the desired output TCP; and (h) control the variable equalizer of the fourth of the plurality of at least four cascading stages to attain the desired output tilt.

In a related embodiment, the first stage of the broadband signal power amplifier further includes a first set of switches configured to switch a signal pathway between pathway 1 and pathway 2, where pathway 1 includes the variable attenuator module and the variable equalizer module of the first stage, and pathway 2 includes a bypass wire between the first set of switches. The variable equalizer module may comprise a second set of switches configured to switch a circuit between pathway 1A and pathway 1B, where pathway 1A includes a cable-simulation module configured to reduce the tilt of a signal passing through pathway 1A, and pathway 1B includes a cable-equalizer module configured to increase the tilt of a signal passing through pathway 1B.

In another related embodiment, the first stage of the broadband signal power amplifier further includes a first set of switches configured to switch a signal pathway between pathway 1 and pathway 2, where pathway 1 includes the variable attenuator module and the variable equalizer module of the first stage, and pathway 2 includes a bypass wire between the first set of switches. The variable equalizer module may comprise a second set of switches configured to switch a circuit between pathway 1A and pathway 1B, where pathway 1A includes a cable-simulation module configured to reduce the tilt of a signal passing through pathway 1A, and pathway 1B includes bypass wire between the second set of switches.

In another embodiment, the variable equalizer module of the first stage includes a set of switches configured to switch a circuit between a pathway 1 and a pathway 2, where pathway 1 includes a cable-simulation module configured to reduce the tilt of a signal passing through pathway 1, and where pathway 2 includes a cable-equalizer module configured to increase the tilt of a signal passing through pathway 2.

In a different embodiment, the variable equalizer module of the first stage includes a set of switches configured to switch a circuit between a pathway 1 and a pathway 2, where pathway 1 includes a cable-simulation module configured to reduce the tilt of a signal passing through pathway 1, and where pathway 2 includes a bypass wire between the set of switches.

The broadband signal power amplifier of this aspect may further include a number of digital potentiometers (DigiPots), each of which is disposed between (i) the variable attenuator module and variable equalizer module of each stage, and (ii) the microcontroller. The amplifier of the first stage may be a push-pull MMIC.

In an aspect, a variable signal equalizer (VEQ) module includes an input switch coupled to an output switch, and the switches are configured to switch a circuit between a first pathway and a second pathway. The first pathway includes a cable simulation module configured to reduce the tilt of a signal passing through the first pathway, and the second pathway includes a cable equalizer module configured to increase the tilt of a signal passing through the second pathway.

In another aspect, a variable signal equalizer (VEQ) module includes an input switch coupled to an output switch, and the switches are configured to switch a circuit between a first pathway and a second pathway. The first pathway includes a cable simulation module configured to reduce the tilt of a signal passing through the first pathway, and the second pathway includes bypass wire between the input switch and the output switch. (As a note, “wire” can mean any electrical connection).

A method of conditioning a broadband signal may be performed on a broadband signal amplifier station that includes: a signal input; a signal-level meter (SLM); a microcontroller communicatively coupled to the SLM; a signal output; a signal pathway between the signal input and the signal output; and a plurality of stages aa signal pathway, wherein each stage includes a variable attenuator module, a variable equalizer module, and an amplifier. The method includes: receiving a broadband signal at the signal input; measuring the per-channel signal levels (PCLs), the total composite power (TCP) and the tilt of the broadband signal via the signal-level meter prior to the first stage; configuring the variable attenuator module and the variable equalizer module of the first stage such that the broadband signal will have nominal TCP at the output of the amplifier of the first stage while preventing any PCL from exceeding an upper threshold or falling below a lower threshold; configuring the variable attenuator modules and the variable equalizer modules of each successive stage such that the broadband signal will have nominal TCP at the output of each amplifier, and such that the signal will have a predetermined tilt and TCP at the signal output; and measuring the PCLs, the TCP, and the tilt of the broadband signal via the signal-level meter prior to the signal output.

The method, in an embodiment, may further include: detecting, based on the measurement prior to the first stage, that at least one PCL of the broadband signal is below a threshold; and configuring the signal pathway, in response to the detection, such that both the variable attenuator module and the variable equalizer module of the first stage are bypassed by the broadband signal.

In another embodiment, the method may further include: detecting, based on the measurement prior to the first stage, that the TCP of the broadband signal is above a threshold and the tilt of the broadband signal is between a lower tilt threshold and an upper tilt threshold; and configuring the signal pathway, in response to the detection, such that the variable equalizer module of the first stage is bypassed by the broadband signal, but the variable attenuator module of the first stage is not.

In yet another embodiment, the method may further include: detecting, based on the measurement prior to the first stage, that the TCP of the broadband signal is above a threshold and the tilt of the broadband signal is above an upper tilt threshold; and configuring the signal pathway, in response to the detection, such that the broadband signal passes through a cable simulator within the variable equalizer module of the first stage, and also passes through the variable attenuator module of the first stage.

In yet another embodiment, the method may further include: detecting, based on the measurement prior to the first stage, that the broadband signal has a lower bandwidth than the amplifier station is configured to process; and reducing, in response to the detection, the level of attenuation of one or more of the variable attenuator modules.

### BRIEF DESCRIPTION OF THE DRAWINGS

FIG. 1 is a schematic diagram of a prior art coaxial cable based CATV system;

FIG. 2 is a graph of the effect that coaxial cable has on a CATV transmission signal;

FIG. 3 is a graph of the effect that an equalizer circuit has when installed at a junction of a CATV coaxial transmission cable;

FIG. 4 is a graph of a resultant equalized output signal after the equalizer circuit of FIG. 3 is connected to coaxial cable carrying the signal of FIG. 2;

FIG. 5 is a graph of an unattenuated CATV transmission signal;

FIG. 6 is a graph of a resultant attenuated output signal after a pad circuit of 10 dB is connected to coaxial cable carrying the signal of FIG. 5;

FIG. 7 is a schematic circuit diagram of a prior art standard CATV amplifier with application of equalization and attenuation;

FIG. 8A is a graph of received signal levels over frequency at different temperatures after transmission over a short cable.

FIG. 8B is a graph of received signal levels over frequency at different temperatures after transmission over a medium cable.

FIG. 8C is a graph of received signal levels over frequency at different temperatures after transmission over a long cable.

FIG. 9 is a graph of an example of CTN, CCN, and CIN over station RF output TCP.

FIG. 10 is a diagram of a distributed ALSC amplifier station.

FIG. 11 is a group of embodiments of circuit topologies and a group of embodiments of VEQ configurations.

FIG. 12 is a graph showing an example of signal levels over frequency at various stages through a distributed ALSC amplifier station.

FIG. 13 is a flow-chart of a method of setting up a distributed ALSC amplifier station.

FIG. 14 is a flow-chart of a method of setting up a distributed ALSC amplifier station.

FIG. 15 is a flow-chart of a method of setting up a distributed ALSC amplifier station.

FIG. 16 is a flow-chart of a method of operation of a distributed ALSC amplifier station.

### DETAILED DESCRIPTION

The basic objective of cascaded amplifiers through trunk cable lines is to provide a lossless transmission between the node output and each amplifier output in the forward (FWD) and in the reverse (REV) direction over temperature variation. However, during this process, the signal channel typically accumulates noise and distortion. Therefore, a second objective is to maintain the composite noise and distortion on the signal channel bandwidth accumulation to a minimum for best MER/CCN performance. In the past, Bode equalizers were commonly used, but their tilt adjustment, level attenuation, and frequency range were limited, and therefore, Bode equalizers are not adequate for faster speed DOCSIS operation over long cable lengths at, e.g., 1.2, 1.8, 3, and 6 GHz modes, etc. In contrast to typical amplifier stations that have one interstage Bode equalizer, the present disclosure describes an amplifier station, and related processes, capable of distributed ALSC, whereby amplification and equalization of a broadband signal is performed across a number of successive stages. This provides better MER/CCN performance as well as wider ALSC/AGC dynamic range control.

Also described herein are system and line extender amplifiers usable in a cable broadband system that have a configurable bandwidth, gain and tilt while using a set of electronically variable equalizers and attenuators across different configurations. The system amplifiers may include, but are not limited to, MOTOROLA MINIBRIDGER (MB), and GAINMAKER HIGH GAIN DUAL (HGD), HIGH GAIN BALANCED TRIPLE (HGBT) amplifiers. Similarly, MOTOROLA BROADBAND LINE EXTENDER, and GAINMAKER LINE EXTENDER amplifiers. The bandwidth is continuously configurable across a range from 1 GHz, 1.2 GHz, 1.8 GHz and beyond, based on the supplied MMIC and power doubler performance limitations. This configurability facilitates cable broadband system upgrades to higher speed, frequency division duplex, and full duplex DOCSIS services, e.g. DOCSIS 3.x to DOCSIS 4.0 system upgrades.

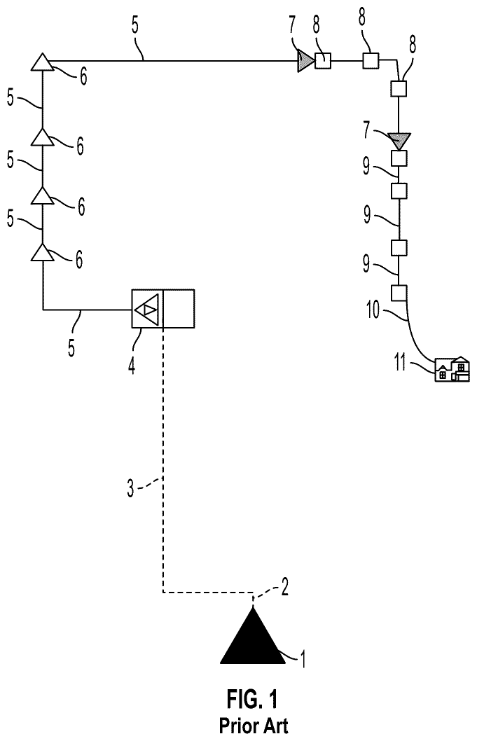

FIG. 1 is a schematic drawing of a typical hybrid fiber/coaxial cable-based broadband/CATV telecommunications system. FIG. 1 can represent a typical cable television system that is currently deployed to service cable television subscribers. In the illustrative example shown in FIG. 1, forward CATV signals originate at a headend facility 1 and are supplied to a fiber optic transmitter 2. The fiber optic transmitter 2 transmits the forward CATV signals to a fiber optic node 4 over fiber optic cable 3 (shown with a dashed line). The fiber optic node 4 also transmits reverse path signals from the subscribers to an optical receiver of the headend 1. An optical receiver in or adjacent to the fiber optic transmitter 2 is not illustrated separately but is typically located in the headend 1 to receive and process these return path signals from the optical node 4. The optical node 4 processes the optical signal and can provide a standard RF output signal. The standard RF output signal is then provided to and carried over a coaxial cable 5 (a trunk or main line) to CATV trunk/network amplifiers 6 that are placed (in series) apart from one another with lengths of coaxial cable 5 therebetween. Depending upon the network architecture, the trunk/network amplifiers 6 can supply the signal to a network of distribution cables 9 that feeds signals to a smaller group of amplifiers, typically referred to as distribution or line-extender amplifiers 7. The distribution amplifiers 7 and distribution cable 9 feed passive devices placed near an end user's location to tap off a main signal supply, which devices are sometimes referred to as distribution or subscriber taps 8. The distribution taps 8 supply a signal tap for a subscriber's coaxial cable service drop 10. The subscriber service drop 10 enters a subscriber location 11 and provides the subscriber with desired services, such as television, high-speed Internet, and/or telephone.

It is noted that this embodiment is just one of many different types of CATV distribution architectures and many cable TV operators utilize different devices and equipment to deploy their services to the end subscriber. However, in many cases, systems that utilize coaxial cable to distribute their services deploy a similar architecture of fiber optic cable, coaxial cable, amplifiers, and passive distribution devices.

The signals transmitted from the headend to the subscriber end are contained within a particular frequency band—the forward (or downstream) path (or channel) of the CATV system. The signals transmitted from the subscriber end to the headend, or to some other upstream station, are transmitted in a different frequency band (higher and/or lower) than the forward path frequency band and these upstream transmissions are referred to as the return (or upstream) path (or channel) of the CATV system. When transmitted over fiber-optic cables, losses in transmission are much improved and are more stable than when transmitted over coaxial cable. Accordingly, different techniques are required for improving transmission quality. The quality of transmission also is different with respect to the intermediate amplifiers used for fiber optic and coaxial cables.

Coaxial cables are constructed with a center conductor surrounded by a dielectric cross-section and an outer conductor, typically made from an aluminum outer shield. The coaxial cable attenuates the signal in a linear function of its conductor resistance. Different sizes of cable, therefore, attenuate the signal flow at different values due to the size of the center conductor and dielectric material. Booster amplifiers 6, 7 are placed along the coaxial cable. The spacing of the amplifiers 6, 7 along a cable route is determined by the loss of the route and is commonly selected based on the recommended operating gain of the amplifier 6, 7. Typically, the booster amplifiers 6, 7 are located at points where the signal levels have been reduced to a pre-designed level. These amplifiers 6, 7 are designed to add a minimum amount of noise and distortion to the processed signals. But, the amplifiers 6, 7 generate additional noise at various points in their circuitry. A ratio of input signal-to-noise to output signal-to-noise is referred to as a noise figure of a given amplifier. The noise figure provides information on the amplifiers thermal noise contribution in cascaded cable transmission systems. As the amplifiers 6, 7 are not perfectly linear, they also contribute additional distortions each time a signal is amplified. Due to the inherent contributions of noise and distortion (e.g., nonlinearity), the signal can only be amplified a certain number of times before the change in the signal, as compared to the signal provided at the headend 1, becomes unacceptable. The cascade effects of the cable 5 and amplifier 6 pair, or the cable 5 and amplifier 7 pair, or a combination of these pairs, typically results in a limited number of continuous cascade due to added noise and distortion on the signal. The limiting factors may include the type of digital modulation employed such as OFDM or 256-, 1024, −2048, or M^{th} Order QAM, the total number of channels, and/or a required signal performance at the end of the cascade.

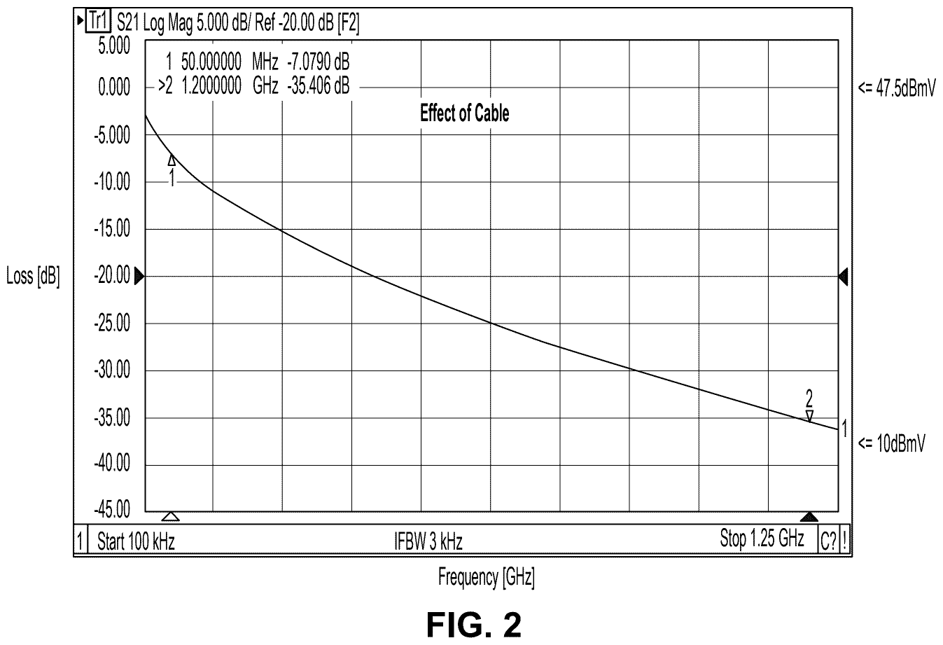

One of the characteristics of coaxial cable is that the signal loss is less at lower frequencies (such as at channel frequency 57 MHz, for example) than at higher frequencies (e.g., at channel frequency 1215 MHz). As an example, the effect of cable loss over frequency on the signal channel levels is depicted in FIG. 2. Therefore, the amplifier 6, 7 needs less amplification at lower frequencies than at higher frequencies. One way of describing this correction is that the output of an amplifier 6, 7 is tilted to ensure minimal noise and distortion performance of the downstream signal flow. The output performance of the cable amplifier 6, 7 is typically reduced for the lower channels in relation to the higher channels based on the total number of channels carried on a cable system. The overall signal levels for all channels should be maintained below a signal level that will not overload the input of any of the amplifier stations that are cascaded prior to reaching the premises, such as a DOCSIS 3.x cable box, television or other signal reception devices.

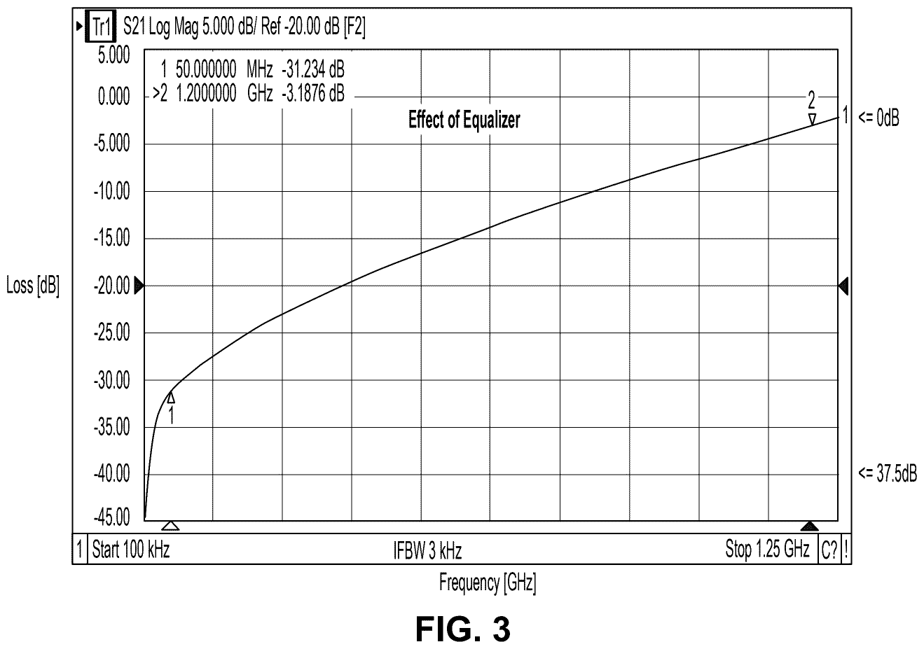

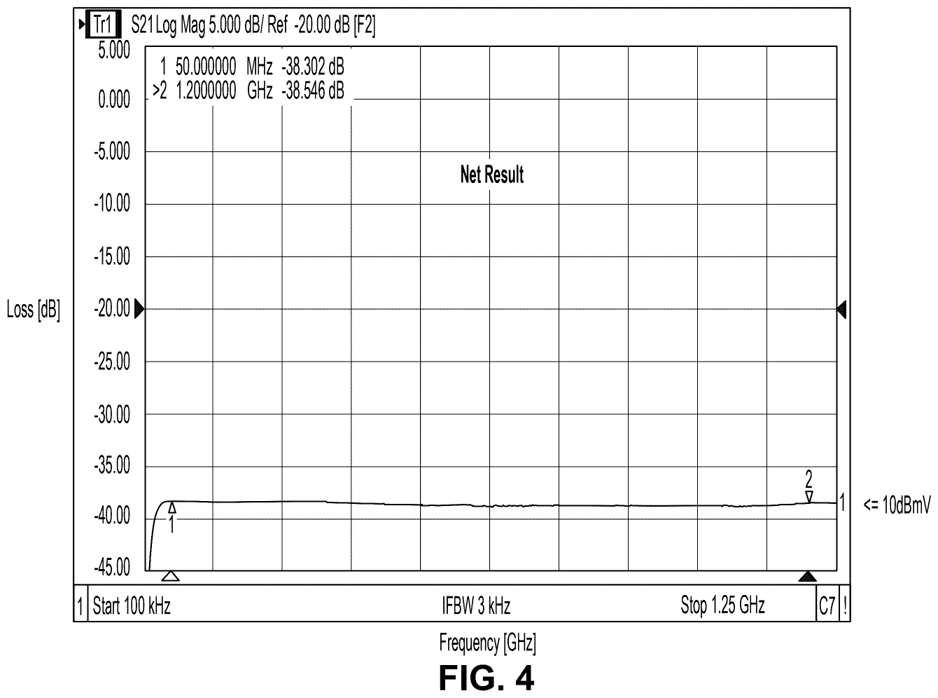

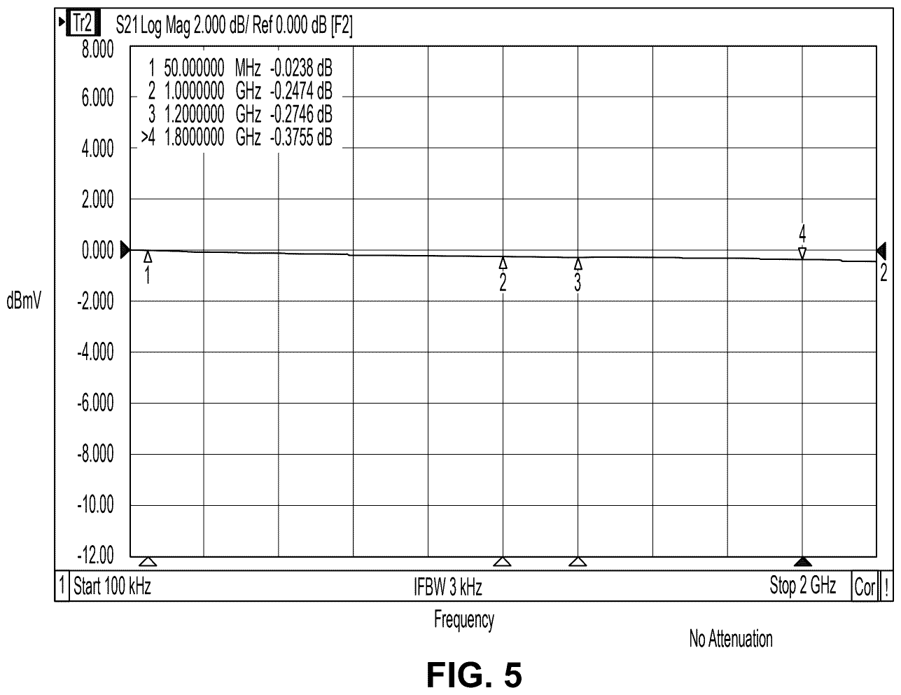

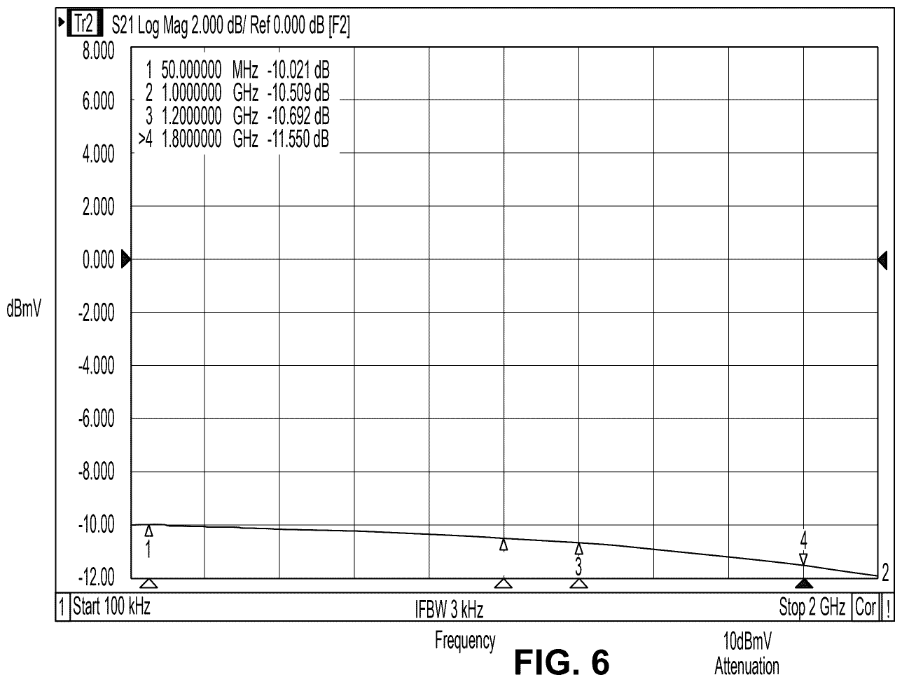

Because coaxial cable loses more signal as the frequency increases, the levels of the lower frequency channels may be reduced to provide equal power levels of all signals. The signal may be adjusted at the input of a given amplifier to reduce or “equalize” these signals, and circuits referred to as equalizers provide the correction for this transmission loss. The behavior of equalizers is shown in the graph of FIG. 3. The slope or tilt of the amplifier gain is adjusted by installing a fixed-value equalizer. These equalizers typically have been available as fixed values in 1 to 1.5 dB increments. To perform equalization at a particular amplifier 6, 7, a field technician selects proper values to balance that amplifier 6, 7 manually to a pre-designed output level, stated in dBmV. The result of applying an equalizer is shown in FIG. 4, in which the equalizer response pattern compliments the response pattern of the cable to produce a flat broadband output signal. A more powerful equalizer can produce an up-tilted broadband output signal. The amplifiers 6, 7 also have a provision for adjusting forward and reverse gain levels. This is commonly accomplished by the installation of a fixed value attenuator, typically referred to as a “pad.” The behavior of a pad is shown in the example of FIGS. 5 and 6 in which a signal (e.g., of 20 dBm V) is not attenuated in the graph of FIG. 5 and the signal is attenuated (e.g., by a 10 dB pad) in FIG. 6.

As the coaxial cable length between amplifier stations increases, cable loss/attenuation increases nonlinearly as a function of increasing frequency and linearly as a function of cable length and cable temperature (environmental temperature where cables are located in the field). The characteristics demanded of the fixed equalizers and fixed attenuators cannot be met easily as cable loss and slope changes over time, temperature, and humidity. Bode equalizers are often used to compensate for temperature variations. Variable Bode equalizers are adjustable equalizer circuits that use temperature-dependent resistors, and/or PIN diodes to control voltage variable attenuators. Legacy cable amplifiers use fixed equalizers, fixed attenuators first (during initial amplifier station instalment and alignment) to compensate for cable loss for that length of cable and rely on Bode variable equalizers to compensate for cable loss temperature variation over time. The pads and cable equalizers (or cable simulators) are commonly plugged into the input of the first gain stage and Bode equalizers are employed at interstage locations that are typically between two gain stages. These are commonly plugged into the amplifier 6, 7 to reduce power levels of the lower channel and reduce power levels uniformly over the signal channel frequency range, respectively. Most legacy amplifiers employ fixed cable equalizers, fixed attenuators/pads and Bode equalizers. Use of Bode equalizers is sometimes known as automatic gain control (AGC) that controls the amplifier gain based on temperature changes measured inside the amplifier housing/station. However, the AGC based on Bode equalizer and temperature look-up tables have very limited tilt and attenuation range for above 860 MHz cascaded cable systems.

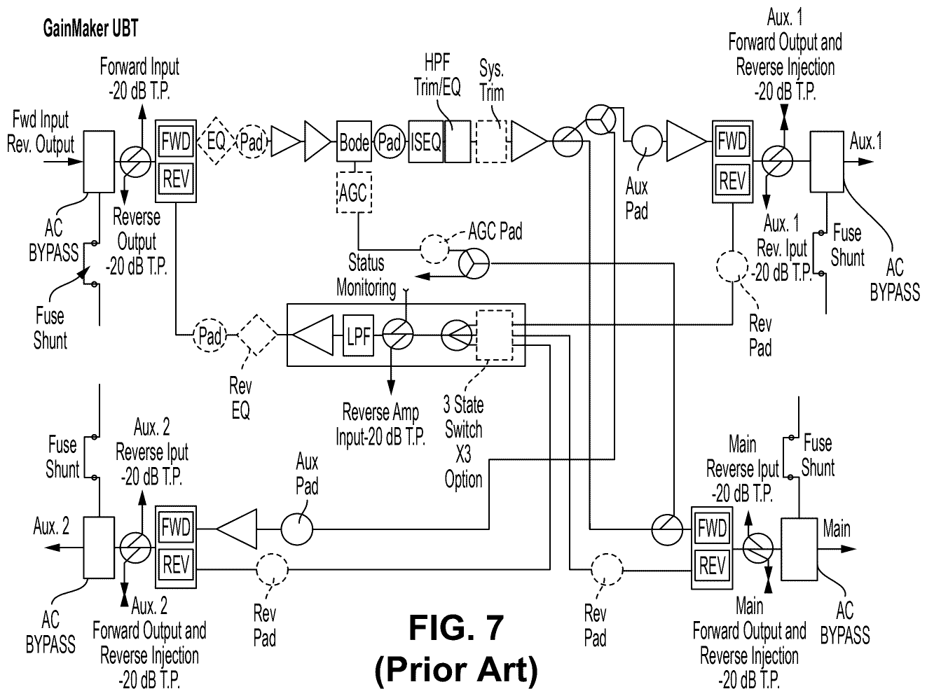

FIG. 7 is a schematic drawing of a typical standard coaxial amplifier 6, 7 and application of plug-in type fixed equalizers and pads. Such amplifiers 6, 7 are typically placed at various locations along the trunk and distribution coaxial cables 5, 9. These amplifiers 6, 7 have specific purposes and are placed at pre-designed locations to amplify and equalize the forward and reverse signals. As those skilled in the art will readily understand, such amplifiers 6, 7 vary in design and in a number of output ports to feed different configurations of coaxial cables. Some models feed only one coaxial cable, known as Line Extender Amplifiers, while others may feed many, for example, three, or five different output cables, known as system amplifiers or multi-port amplifiers (in legacy CATV networks these were known as trunk, or bridger amplifiers).

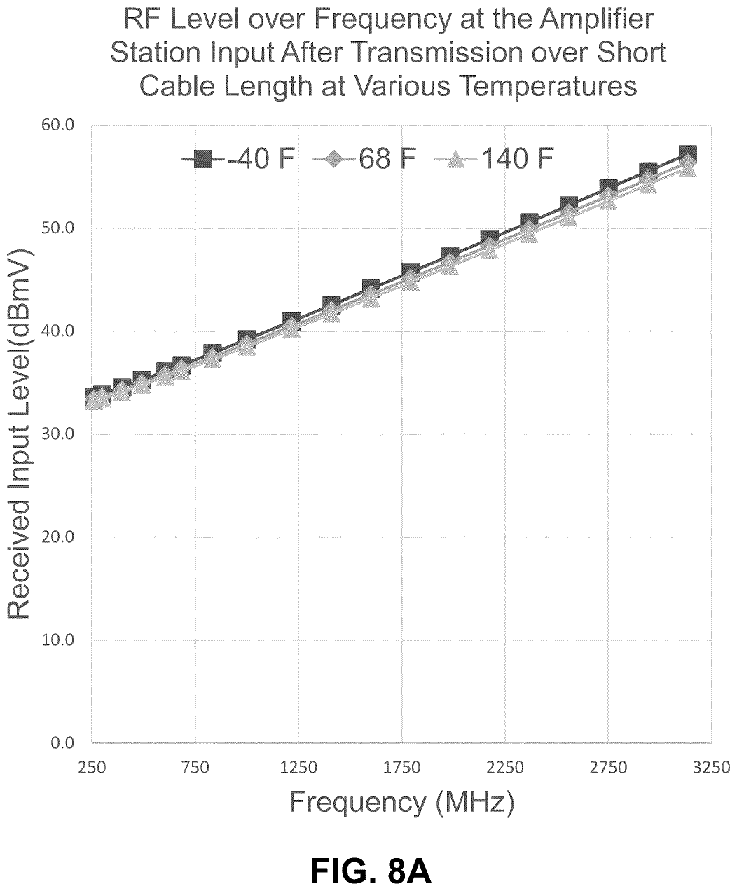

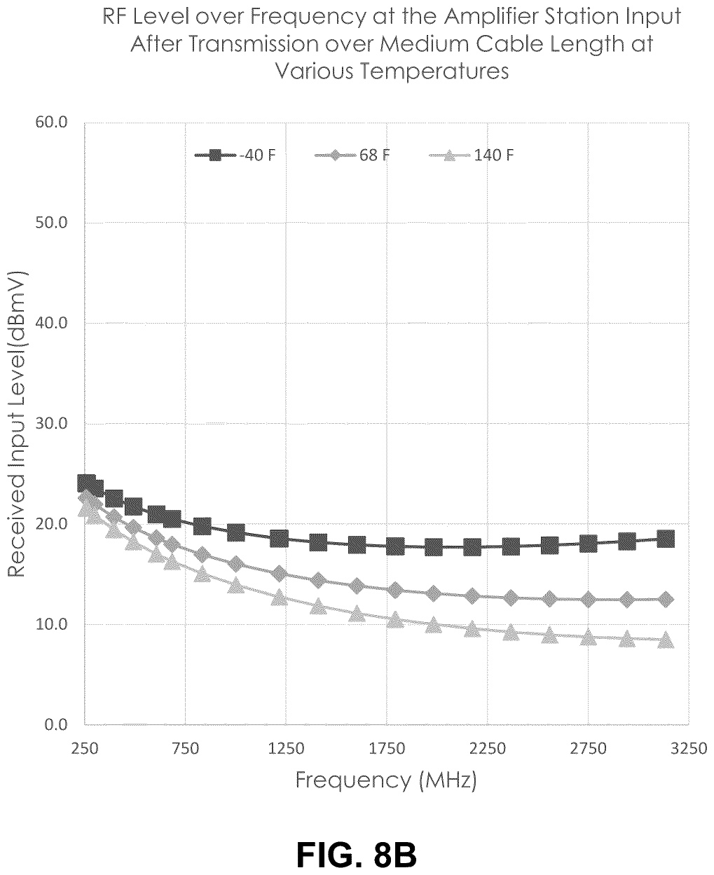

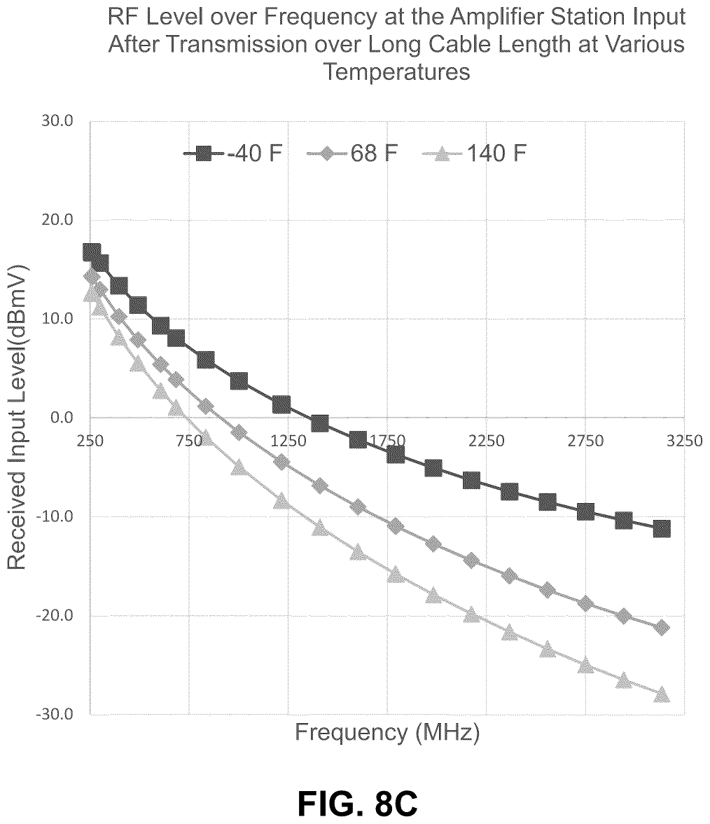

FIGS. 8A-8C depict examples of received input power levels over a range of frequencies at varying temperatures and cable lengths leading into the amplifier. FIG. 8A shows the RF level over frequency after transmission over a short cable. As can be seen, there is little difference in level from either temperature variations or frequency. The broadband signal, which was launched from the previous amplifier or source with an up-tilt, remains up-tilted with little loss. FIG. 8B shows the RF level over frequency after transmission over a medium length cable. The cable causes greater loss at higher frequencies resulting in a down-tilt, and higher temperatures also result in greater losses. This effect is even more pronounced in FIG. 8C, which depicts RF level over frequency after transmission over a long cable. The cable loss and resulting down-tilt is greater, and the variation between temperatures is also greater. These effects can cause reduced performance in typical amplifiers that are less capable of compensating for these non-linear losses.

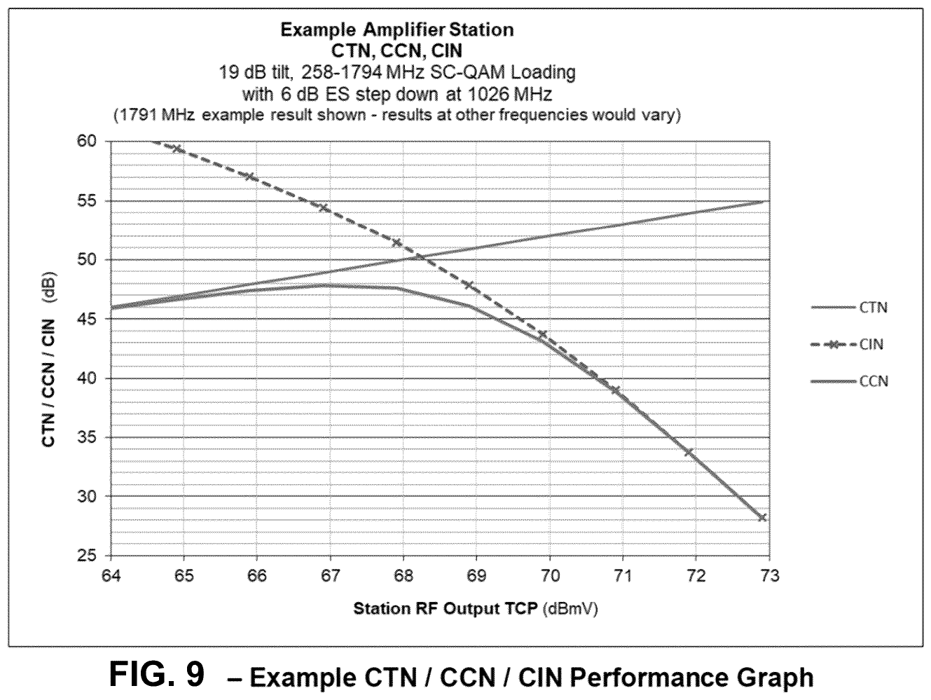

FIG. 9 depicts a chart, for an example amplifier station, of Carrier-to-Thermal-Noise (CTN), Carrier-to-Composite-Noise (CCN), and Carrier-to-Intermodulation-Noise (CIN) performance over the station RF output Total Composite Power (TCP). As shown, CTN increases linearly with TCP, CIN drops off steadily as TCP increases, and CCN reaches a peak around 67 dBmV of TCP (in this example). Note that CCN describes the overall combined effect of both the CTN (noise) and the CIN (distortion) of the amplifier station. In the example shown in FIG. 9, the ideal CCN performance occurs around 67 dBmV, which, along with an associated tolerance, may be referred to as a “nominal TCP”. The limits of the tolerance may be referred to as a “noise floor” and “distortion ceiling”, or “TCP min and max”. For example, nominal TCP can take a value between 64 to 69 dBm V for an amplifier that requires a CCN>46 dB. Nominal TCP may differ depending on each amplifier.

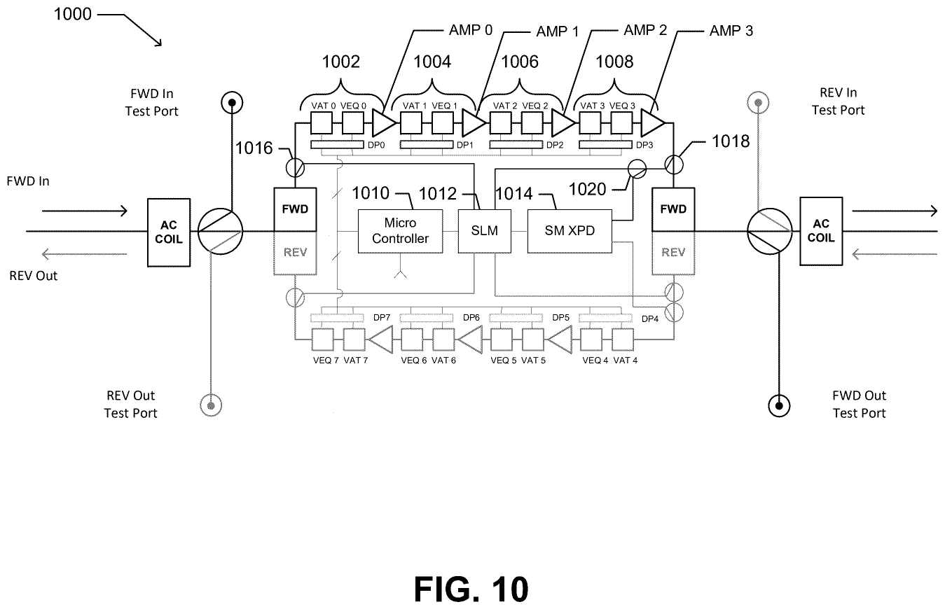

FIG. 10 depicts a diagram of a distributive ALSC (Automatic Level & Slope Control) amplifier station 1000 according to an embodiment of the present disclosure. For simplification purposes, only the forward signal direction will be described in detail, but the reverse direction operates in an identical manner. The amplifier station 1000 contains at least two (in this case four) stages: stage 0 1002, stage 1 1004, stage 2 1006, and stage 3 1008. Each stage contains a variable attenuator (VAT), a variable equalizer (VEQ), and an amplifier (AMP), as well as a dual digital potentiometer (DigiPot, “DP”), or a dual digital-analog converter (DAC). The VATs may contain variable attenuator modules, fixed attenuator modules, or both. The VEQs may contain variable equalizer modules, fixed equalizer modules, or both. Each VAT and VEQ may be separately controllable. The AMPs may be fixed. The station 1000 also includes a micro-controller 1010, a signal-level monitor (SLM) 1012, and a status monitoring transponder (SM XPD) 1014. The DPs (DP0-DP3) are disposed between the corresponding VATs and VEQs and the micro-controller 1010. The micro-controller may send control signals to each VAT and/or VEQ to adjust the attenuation and/or equalization of the broadcast signal. The micro-controller 1010 may have one or more communication connections, such as USB, WiFi, Bluetooth, etc., through which an operator may interface with, and send commands to, the station 1000.

As the broadband signal, after transmission through the cable causes attenuation and shaping as a function of frequency, cable length, and cable temperature, enters the amplifier station 1000, it passes through an AC bypass coil, the forward-in/reverse-out test port and forward-/reverse-split diplexer filter before it reaches a line splitter (or directional coupler) 1016 connecting the signal line to stage 0 1002 and the SLM 1012. The SLM 1012, via the splitter 1016, measures the per-channel power level and the total composite power (TCP) level of the signal before the signal enters stage 0 1002, and provides its measurements to the micro-controller 1010, which may also calculate the signal's slope or tilt (difference in level between the highest channel and the lowest channel) based on the per-channel power levels (PCL). The transmitted signal channel levels are launched by the previous amplifier with a linear positive tilt (pre-emphasis), This partially compensates for the cable loss (which is a nonlinear function of frequency) experienced by the transmit signals over longer cable lengths. The received signal results in a concave-curved shape with a positive slope for short, or a zero slope for medium, or a negative slope for long cable transmission lengths, respectively.

At stage 0 1002, the signal passes through VAT 0 and VEQ 0 before it enters AMP 0. At VAT 0, the signal may be attenuated by a certain amount if the TCP is above the maximum allowable threshold at AMP 0 output in order not to introduce too much distortion. However, the amount of flat attenuation applied by VAT 0 is limited because the signal levels should not be reduced below the system noise floor at AMP 0 output in order not to introduce too much noise onto one or more channels. Therefore, the measured TCP should be kept between the minimum and maximum TCP threshold limits (i.e., nominal TCP range to maintain nominal CCN/MER performance) at AMP 0 output. At VEQ 0, the signal passes through a cable equalizer where the signal may be equalized (i.e., attenuated as a function of frequency with positive slope) or pass through a cable simulator where the signal may be inverse equalized (i.e., attenuated as a function of frequency with a negative slope). The flat attenuation applied by VAT 0 and the frequency dependent attenuation applied by VEQ 0 maintains AMP 0 output TCP within the defined nominal range. Keeping TCP in this range minimizes signal degradation introduced by distortion due to overload and noise due to received low input signal levels. In some embodiments, VAT 0, VEQ 0, or both, may be bypassed and at AMP 0, the signal is amplified. AMP 0 may be a push-pull type MMIC, which can provide sufficient gain to offset losses if VEQs or other components are tuned for a higher bandwidth than the incoming broadband signal has (e.g., 1.8 GHz vs. 1.2 GHZ). The signal then passes through VAT 1, VEQ 1, AMP 1, VAT 2, VEQ 2, AMP 2, VAT 3, VEQ 3, and AMP 3, undergoing successive periods of amplification, attenuation, and equalization, before reaching line splitter 1018, which connects to a line to splitter 1020, which splits the line between the SLM 1012, and the SM XPD 1014. The SLM 1012 measures the per-channel power levels and the TCP of this line, and provides the measurements to the micro-controller 1010. The SM XPD 1014 is coupled to the micro-controller 1010 and is a status monitoring transponder, which allows remote monitoring of the signal and control of the station 1000. After passing splitter 1018, the signal passes the forward out test port, an AC coil, and out of the amplifier station 1000. Based on the signal measurements taken after the input (before stages 0-3) and the signal measurements taken before the output (after stages 0-3), the micro-controller 1010 may adjust the operation of the VATs and VEQs such that the signal remains around the peak CCN defined within the nominal TCP range, throughout the amplifier station 1000. This minimizes noise and distortion introduced by the amplifier station 1000 and helps preserve signal fidelity. While the signal may only be measured before stages 0-3 (1002-1008) and after stages 0-3, and optionally, after stage 0, the per-channel power level and TCP may be interpolated such that the signal characteristics between stages 0 and 3 may be known or closely estimated.

Certain equations are useful for understanding signal performance.

Cable loss may be calculated by using the following function:

$$CableLoss ( f ) = L ( {af}^{b} + {cf}^{d} ) \cdot ( 1 + 0.0011 ( T - 68 ) )$$

where:
L is the length of cable;
f is the frequency;
T is the cable temperature; and
a, b, c, d, are coefficients for the cable type, for example, CommScope PIII 0750 or 0500, used.

Cable equalization and its characteristic shape defined at frequencies f to f_{Lch} can be expressed using the following function:

$$CEQ ( f ) = {Loss}_{0} - {Loss}_{0} / ( {af}_{Lch}^{b} + {cf}_{Lch}^{d} ) \cdot ( {af}^{b} + {cf}^{d} )$$

where:
Loss₀ is the equalizer value, i.e., if the desired tilt is CEQ(f_{Lch})−CEQ(f_{Fch})=TILT₀, then the loss between the Lch (last channel) and Fch (first channel) channel frequencies, is used to determine Loss₀;
f_{Lch} is the last (i.e., highest) channel frequency;
f is the desired frequency; and
a, b, c, d, are coefficients for the cable equalizer that matches the cable shape.

If M is the total number of stages such that m=0, 1, . . . , M−1, then the i^{th} channel signal level at the output of the m^{th} stage, as a function of channel frequency, can be determined simply as:

$${Y}_{m} ( {f}_{i} ) = InputLevel ( {f}_{i} ) + {\sum }_{j = 0}^{m} [ {NetGain}_{j} ( {f}_{i} ) - {CEQ}_{j} ( {f}_{i} ) - {VAT}_{j} ( {f}_{i} ) ]$$

In the above expression, InputLevel can be obtained by measuring the per-channel levels at the first splitter 1016, Y_{0,i}.

$${InputLevel}_{i} = InputLoss + {Y}_{0 , i}$$

where InputLoss, and NetGain are pre-measured quantities during the calibration process of the hardware. NetGainⱼ₋₁ is the amplifier gain including through losses due to stage input components, RF transmission lines and impedance mismatches at the j^{th} stage. VAT is the attenuation. The frequency of the i^{th} signal channel, fᵢ can be found by:

$${f}_{i} = \frac{L c h - F c h}{N - 1} \cdot ( i - 1 ) + Fch , i = 1 , 2 , ⋯ , N$$

where:
N is the total number of channels;
Lch is the last (i.e., highest) channel frequency; and
Fch is the first (i.e., lowest) channel frequency.

After some algebraic manipulation, the channel signal level at the output of each stage can be calculated using the following recursive expression:

$${Y}_{M - 2 , i} = {Y}_{M - 1 , i} - [ {NetGain}_{M - 1 , i} - {CEQ}_{M - 1 , i} - {VAT}_{M - 1 , i} ]$$

The per-channel signal level (PCL) at the amplifier station output, including output stage losses, is given by:

$${Y}_{M , i} = {OutputLevel}_{i} = - OutputLoss + {Y}_{M - 1 , i}$$

where OutputLoss is a pre-measured quantity due to hardware.

The i^{th} per channel signal level at the M^{th} stage output can be obtained by using the measured Lch level Y_{M-1,N} and TILT₀ as follows:

$${Y}_{M - 1 , i} = \frac{{TILT}_{0}}{N - 1} ( i - 1 ) + {Y}_{M - 1 , N} - {TILT}_{0}$$

The TILT₀ at the amplifier station output is linear. Therefore, TCP at the output of the amplifier station can be determined using Geometric series in a closed form expression as follows:

$${TCP}_{M} = 10 {log}_{10} {10}^{\frac{{Y}_{M , N} - {TILT}_{0}}{10}} [ \frac{1 - {10}^{\frac{\frac{{TILT}_{0} \cdot N}{( N - 1 )}}{10}}}{1 - {10}^{\frac{\frac{{TILT}_{0}}{( N - 1 )}}{10}}} ]$$

And TCP at the output of the m^{th} stage can be expressed by:

$${TCP}_{m} = 10 {log}_{10} {\sum }_{i = 1}^{N} [ {10}^{\frac{{Y}_{m - 1 , i}}{10}} \cdot {10}^{\frac{- {NetGain}_{m , i}}{10}} \cdot {10}^{\frac{{CEQ}_{m , i} + {VAT}_{m , i}}{10}} ]$$

Depending on the length of cable and temperature, the received input level is expected to vary widely over time. At any instance of time, the difference between the transmitted and received slope at the amplifier station 1000 output and input, respectively, provides the required tilt correction, TILTₒₚ, and attenuation, ATTₒₚ. Note that fixed tilt due to components and filters contributed at each stage is subtracted out as follows:

$${TILT}_{op} = {TILT}_{out} - {TILT}_{i n} - {TILT}_{fixed}$$

If αₘ is the fraction of the tilt correction and Bm is the fraction of the level attenuation correction then:

$${TILT}_{op} = {TILT}_{op} ( {α}_{0} + {α}_{1} + ⋯ + {α}_{M - 1} ) = {TILT}_{0} + {TILT}_{1} + ⋯ + {TILT}_{M - 1}$$

$$Similarly , \\ {ATT}_{op} = {ATT}_{op} ( {β}_{0} + {β}_{1} + ⋯ + {β}_{M - 1} ) = {ATT}_{0} + {ATT}_{1} + ⋯ + {ATT}_{M - 1}$$

The tilt and attenuation values at each stage of a 4 stage HGD amplifier is determined for 2000 ft cable at different plant temperatures for both 1.8 GHz mode (Table 1A), 1.2 GHz mode using CEQ LO (Table 1B) and 1.2 GHz mode using CEQ HI (Table 1C). Table 1A and B shows that as the temperature varies the tilt and attenuation control values vary at each stage distributively.

TABLE 1A
1.8 GHz Mode Auto-Aligned Amplifier Using CEQ HI
at Stages 1-3: Tilt and Attenuation Values Determined
for 2000 ft Cable at Various Temperatures

| | −40° F. | 68° F. | 140° F. |
|---|---|---|---|
| TILT 0 | 0 | 0 | 0 |
| TILT 1 | 8.7 | 11.2 | 11.2 |
| TILT 2 | 5.5 | 5.9 | 10.9 |
| TILT 3 | 1.7 | 2.4 | 0 |
| ATT 0 | 5.7 | 0 | 0 |
| ATT 1 | 7.3 | 7.3 | 3.5 |
| ATT 2 | 1.3 | 1.3 | 1.3 |
| ATT 3 | 1.3 | 1.3 | 1.3 |

TABLE 1B
1.2 GHz Mode Auto-Aligned Amplifier Using CEQ LO
at Stages 1-3: Tilt and Attenuation Values Determined
for 2000 ft Cable at Various Temperatures

| | −40° F. | 68° F. | 140° F. |
|---|---|---|---|
| TILT 0 | 0 | 0 | 0 |
| TILT 1 | 2.9 | 3.5 | 4.4 |
| TILT 2 | 2.9 | 4 | 4.4 |
| TILT 3 | 2.9 | 4 | 4.4 |
| ATT 0 | 11.2 | 7.8 | 0 |
| ATT 1 | 6.2 | 5.4 | 7.3 |
| ATT 2 | 4.9 | 4.6 | 6 |
| ATT 3 | 1.3 | 1.3 | 2.7 |

TABLE 1C
1.2 GHz Mode Auto-Aligned Amplifier Using CEQ HI
at Stages 1-3: Tilt and Attenuation Values Determined
for 2000 ft Cable at Various Temperatures

| | −40° F. | 68° F. | 140° F. |
|---|---|---|---|
| TILT 0 | 0 | 0 | 0 |
| TILT 1 | 3.6 | 4.4 | 5.1 |
| TILT 2 | 3.2 | 4.3 | 4.8 |
| TILT 3 | 3.4 | 4.2 | 4.6 |
| ATT 0 | 10.9 | 6.9 | 0 |
| ATT 1 | 1.7 | 1.3 | 2.9 |
| ATT 2 | 3 | 1.7 | 3.1 |
| ATT 3 | 1.3 | 1.3 | 1.3 |

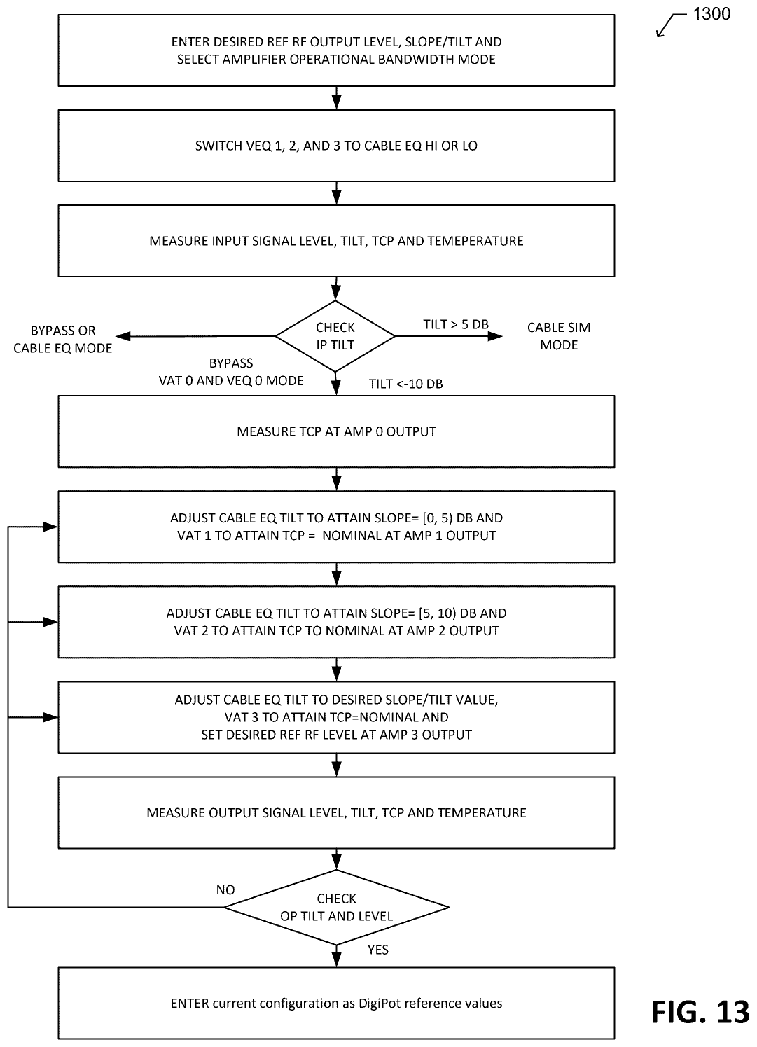

These values are determined at each stage from the VEQs and VATs during initial set-up (“Auto-Align”) and when the feedback control loop “ALSC On” is closed. Refer to FIGS. 13-16 for these processes.

As a note, the typical objective of the amplifier station is to provide the necessary gain and shape such that NetGainM-1 equals zero over frequency (i.e., is flat). Therefore, the RF output levels per channel from the previous amplifier should typically have the same tilt and shape as the output level of the current station 1000.

In an example, the worst-case system noise floor can be derived by assuming the outside plant temperature is at 60° C. (140° F.) and the inside housing temperature is 90° C. The amplifier station input losses, VAT 0, and VEQ 0 excess insertion losses, contribute to overall noise figure to about 8 dB. The system thermal noise floor within the analog baseband channel bandwidth, NBW is 4 MHz, can be expressed as follows:

$$\begin{matrix}System Noise Floor = - 173 + NF + 10 {log}_{10} NBW + 48.75 \\ = - 50.2 dBmV\end{matrix}$$

Using the CTN formula, the minimum required pre-channel level at the amplifier input can be determined as:

$$Min . Required Input PCL = CTN + Noise Floor .$$

The system-required minimum CTN=50 dB, therefore, the minimum required input PCL is ˜0 dBmV. If bypass mode (i.e., bypassing VEQ 0), or bypass-bypass mode (i.e., bypassing VAT 0 and VEQ 0), is used, for long cable transmission, we can improve the NF by ˜1 or 3 dB, respectively. Therefore, using bypass-bypass mode, the minimum PCL ˜−3 dBmV allows us to achieve our system CCN (assuming CCN=˜ CTN) performance over longest cable lengths. We have assumed amplifier distortion is not a contribution for CCN near the minimum TCP limit.

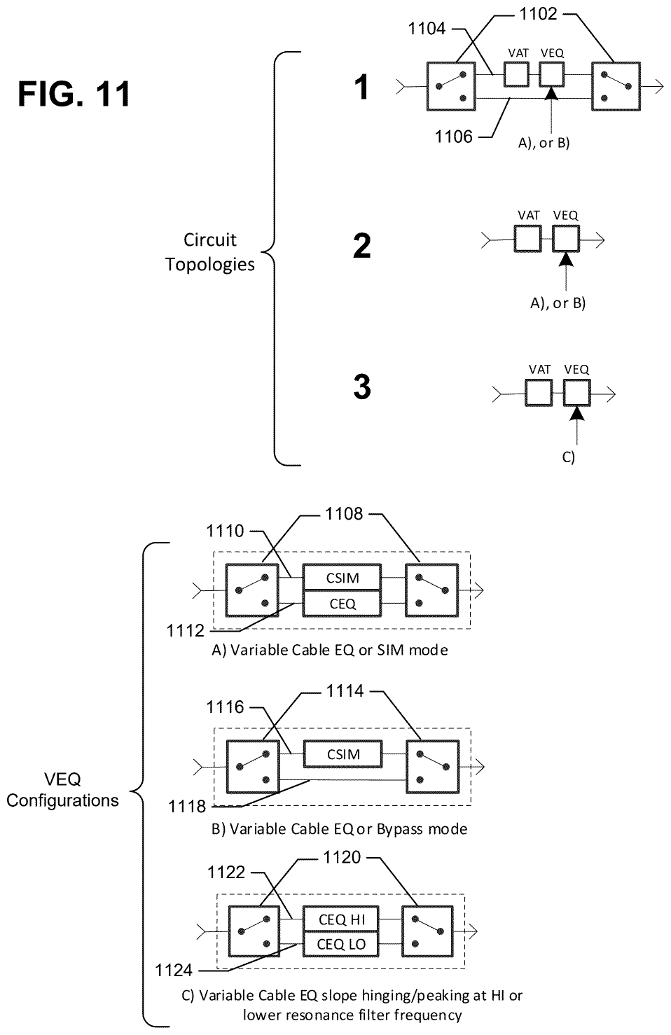

FIG. 11 shows several embodiments of circuit topologies and VEQ configurations. All of the switches shown in FIG. 11 may be controlled by the micro-controller 1010. The circuit topologies (1, 2, and 3) may be used at the stages 0-3 (1002-1008). Circuit topology 1 includes a set of switches 1102, which can change a signal pathway from a first pathway 1104 to a second pathway 1106. The first pathway 1104 includes a VAT and VEQ, while the second pathway 1106 includes only a bypass wire (which may broadly include any suitable electronic connector). Circuit topology 1 may typically be used at stage 0 (1002) or stage 1 (1004), where it may be desirable to skip attenuation and equalization. For example, if the signal at the input is very low power, attenuation and/or equalization may put one or more channels in the range of the noise floor, which is undesirable; thus, the first VAT(s) and VEQ(s) may be skipped to allow the signal to be amplified before it is attenuated and/or equalized. In circuit topology 1, the included VEQ may typically have one of VEQ configurations A or B. Circuit topology 2 may typically be used at stage 0 (1002) or stage 1 (1004), but does not contain a bypass, so a signal passing through it will pass through the VAT and VEQ. In circuit topology 2, the included VEQ may typically have one of VEQ configurations A or B. Circuit topology 3 may typically be used at stage 2 (1006) or stage 3 (1008), and the included VEQ may typically have VEQ configuration C.

VEQ configuration A includes a set of switches 1108, which can change a signal pathway from a first pathway 1110 to second pathway 1112. The first pathway 1110 may include a cable simulation module (CSIM) (which may be variable or fixed), while the second pathway 1112 may include a cable equalizer module (CEQ) (which may be variable or fixed). VEQ configuration A thus allows toggling between decreasing tilt of a signal via the CSIM and increasing tilt of a signal via the CEQ.

VEQ configuration B may include a set of switches 1114, which can change a signal pathway from a first pathway 1116 to second pathway 1118. The first pathway 1116 may include a cable simulation module (CSIM) (which may be variable or fixed), while the second pathway 1118 may include a bypass wire. VEQ configuration B thus allows toggling between decreasing tilt of a signal via the CSIM and bypassing without changing the tilt.

VEQ configuration C may include a set of switches 1120, which can change a signal pathway from a first pathway 1122 to second pathway 1124. The first pathway 1122 may include a cable-equalizer module that peaks at a high frequency (CEQ HI) (and which may be variable or fixed or both), while the second pathway 1124 may include a cable-equalizer module that peaks at a lower frequency (CEQ LO) (and which may be variable or fixed or both). VEQ configuration C thus allows toggling between a low frequency equalizer and a high frequency equalizer. For example, if the broadband signal has a 1.2 GHz bandwidth, the CEQ LO may be used, but if the broadband signal has a 1.8 GHz bandwidth, the CEQ HI may be used. The toggle between CEQ LO and CEQ HI allows the station 1000 to be, for example, installed in, and optimized for, a network that operates at a 1.2 GHz bandwidth, and quickly and easily re-optimized for 1.8 GHz operation when the network is eventually upgraded. In some embodiments, some of the stages 0-3 may only have CEQ HI present without a toggle switch and the CEQ LO. For example, if CEQ HI operates at 1.8 GHZ, it can operate at 1.2 GHz bandwidth (not vice versa) and when tilted has additional excess loss. However, the amplifier station 1000 has sufficient gain to overcome this excess loss by releasing attenuation on VATs in stage 0-3 (i.e., reducing attenuation on VATs increases the overall gain of the amplifier station). TABLE 1C shows that ATT values in stage 0-3 are higher using CEQ HI (1.8 GHz bandwidth) than the ATT values in stage 0-3 using CEQ LO (1.2 GHz bandwidth) shown in TABLE 1B. Therefore, operation of amplifier station using CEQ HI can be easily used without resorting to CEQ LO for 1.2 GHz or 1.0 GHz bandwidth operation.

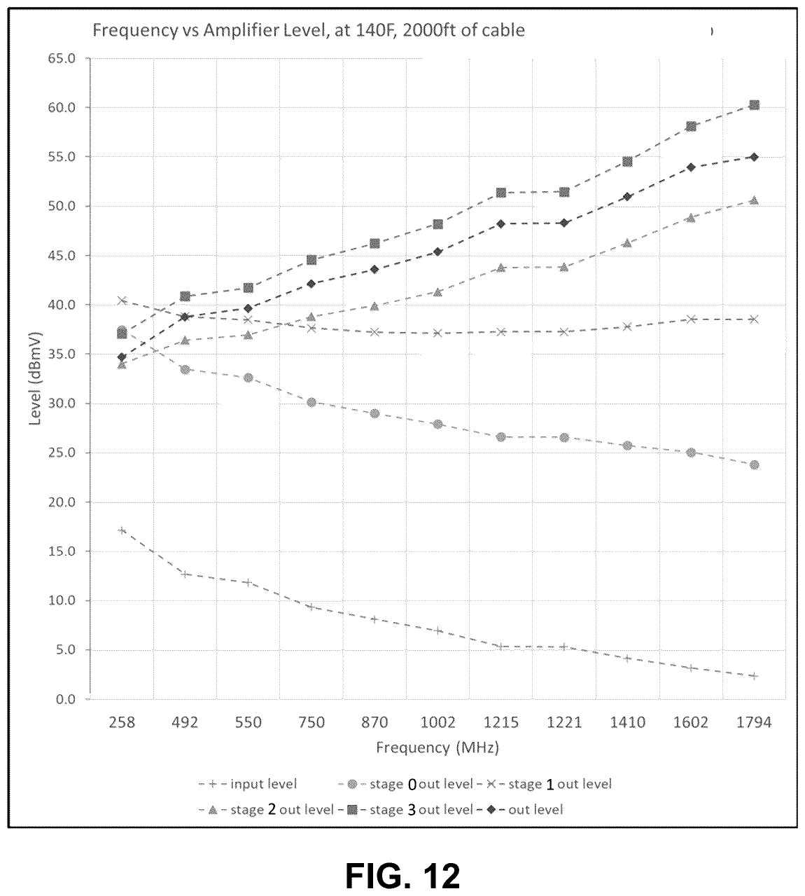

FIG. 12 depicts an example of a signal's per-channel level measurements as it passes through the amplifier station 1000. In this example, the temperature is 140 F, and the cable between the previous station and the station 1000 is 2000 ft long. Although only 11 data points per step are shown, there may be, for example, 256 channels in a broadband signal. The signal levels at the input to the station 1000 are marked with plusses (+). At the input, the signal level is relatively low, and there is a down-tilt such that higher frequencies have lower levels than lower frequencies. This is primarily due to the loss caused by the transmission along a long cable. With input level measurements as shown, immediate attenuation and/or equalization of the signal could cause one or more channels to approach the system noise floor, degrading the signal fidelity. Therefore, at stage 0 (1002), VAT 0 and VEQ 0 may be bypassed, and the signal will reach AMP 0, which will boost the level of every channel approximately equal amounts. This results in the stage 0 out levels, which are marked with circles (●). At stage 1 (1004), the signal may be equalized, resulting in the relatively flat tilt shown, attenuated and amplified, resulting in the stage 1 out levels, which are marked with x's (x). At stage 2 (1006), the signal will be, again, attenuated, equalized, and amplified, resulting in levels with an up-tilt and a higher TCP as shown in the stage 2 out levels, which are marked with triangles (▴). At stage 3 (1008), the signal will be, again, attenuated, equalized, and amplified, to further fine-tune the signal into its desired tilt and TCP at the output. This results in the stage 3 out levels, which are marked with squares (▪). The signal will undergo some expected loss between the stage 3 (1008) output and the output from the station, which results in launching the signal at the final output levels marked by diamonds (♦). As the signal travels along the cable, it will experience loss and down-tilting, resulting in an eventual need for another amplifier station. In the example shown in FIG. 12, nominal TCP range may be 54 to 63 dBmV, and therefore the station 1000 will be configured such that the signal is kept within or as close to that range as possible, to minimize signal fidelity loss through the station 1000. Note that FIG. 12 shows PCL values, not TCP values. The nominal TCP range, and the optimal TCP (in terms of peak CCN) may be specific to each AMP, and so the station 1000 may configure each VAT and VEQ such that the output of each AMP is within nominal TCP, and ideally close to optimal TCP.

FIG. 13 depicts a flow chart of an exemplary process 1300 for setting up an amplifier station 1000. One or more steps of process 1300 may be performed by an operator, and one or more steps of process 1300 may be performed automatically by the station 1000. The process 1300 begins with entering a desired reference RF output level and tilt, and selecting an amplifier operational bandwidth mode via a user interface in communication with the micro-controller 1010. The operational bandwidth mode may be, e.g., 1.0 GHz, or 1.2 GHz or 1.8 GHZ, based on the bandwidth of the incoming signal. One or more of the VEQs (typically) VEQs 1, 2, and 3) may then be switched to CEQ HI or CEQ LO, based on the operational bandwidth mode. Then the input signal level, tilt, TCP, and the temperature are measured. The station 1000 may operate in one of several modes based on the tilt of the signal at the input. In the example of process 1300, the tilt is measured at less than-10 dBmV, i.e., the signal is significantly down-tilted. For this reason, VAT 0 and VEQ 0 are bypassed, e.g., via pathway 1106 of circuit topology 1. At the output of AMP 0, the TCP of the signal may be measured. Because VEQ 0 was bypassed, the tilt should be approximately the same as at the input.

VEQ 1 may then be adjusted to attain a signal tilt (a.k.a. slope) of between 0 and 5 dB and VAT 1 may be adjusted to attain a TCP within the nominal range, e.g., 54 to 63 dBmV, at the output of AMP 1. VEQ 2 may then be adjusted to attain a signal tilt of between 5 and 10 dB, and VAT 2 may be adjusted to attain nominal TCP at the output of AMP 2. VEQ 3 may then be adjusted to attain a desired tilt value (which may be based on the length of cable to the next amplifier station), and VAT 3 may be adjusted to attain TCP within the nominal range at the output of AMP 3, which may be higher (e.g., 68-72 dBmV) if AMP 3 is a push-pull type MMIC amplifier. A desired reference RF level (i.e., the highest frequency channel level) at the AMP 3 output may then be set. The output per-channel signal levels, tilt, TCP, and the temperature may then be measured. At this point, the output signal tilt and levels should be checked and compared to the desired output tilt and levels. If the signal tilt and levels are within an acceptable tolerance of the desired values, then the station 1000 may enter (and save) the current configuration values as the DigiPot reference values. If the signal tilt and level are not within an acceptable tolerance of the desired values, then the VATs and VEQs may be readjusted until they are.

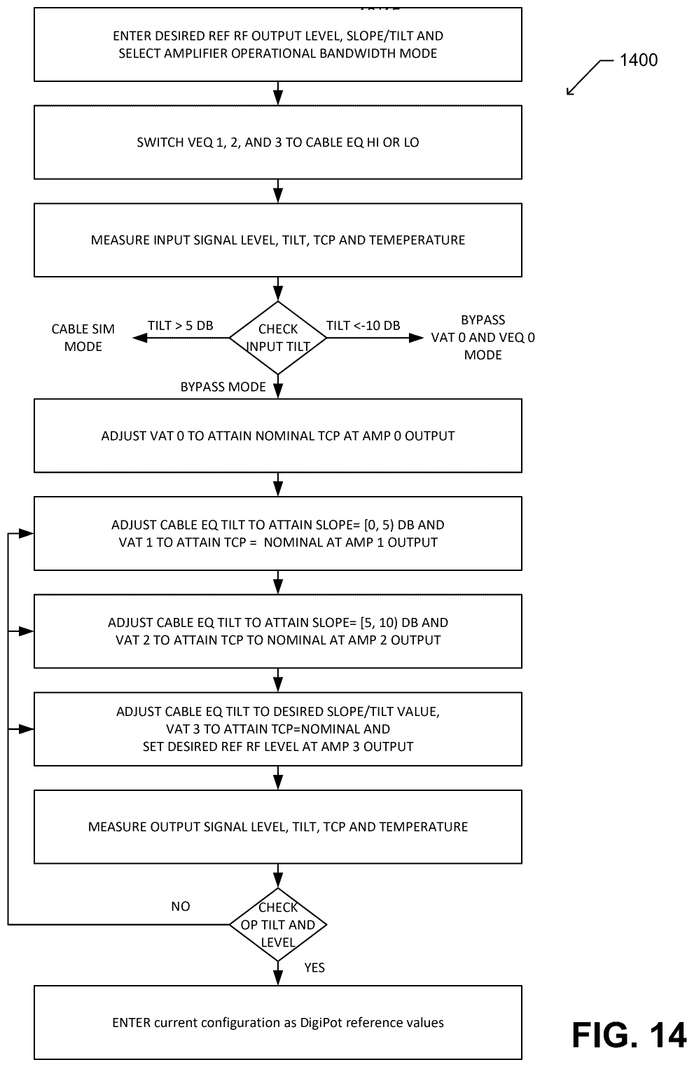

FIG. 14 depicts a flow chart of an exemplary process 1400 for setting up an amplifier station 1000. One or more steps of process 1400 may be performed by an operator, and one or more steps of process 1400 may be performed automatically by the station 1000. The process 1400 is in many places identical to process 1300, and identical steps will not be redundantly described. In the example of process 1400, the signal tilt at the input is measured between −10 dB and +5 dB. Therefore, it may be unnecessary to equalize the signal up-front, but may be beneficial to attenuate the signal such that it is not over-boosted by AMP 0. VEQ configuration B, of circuit topology 1 or 2 may be used in this example, with pathway 1118 used to bypass VEQ 0 without CEQ or CSIM. It is desirable for the signal to be near nominal TCP to maintain maximal CCN. Thus, VAT 0 may be adjusted to attain TCP within the nominal range at the output of AMP 0. The remaining steps of process 1400 are identical to process 1300.

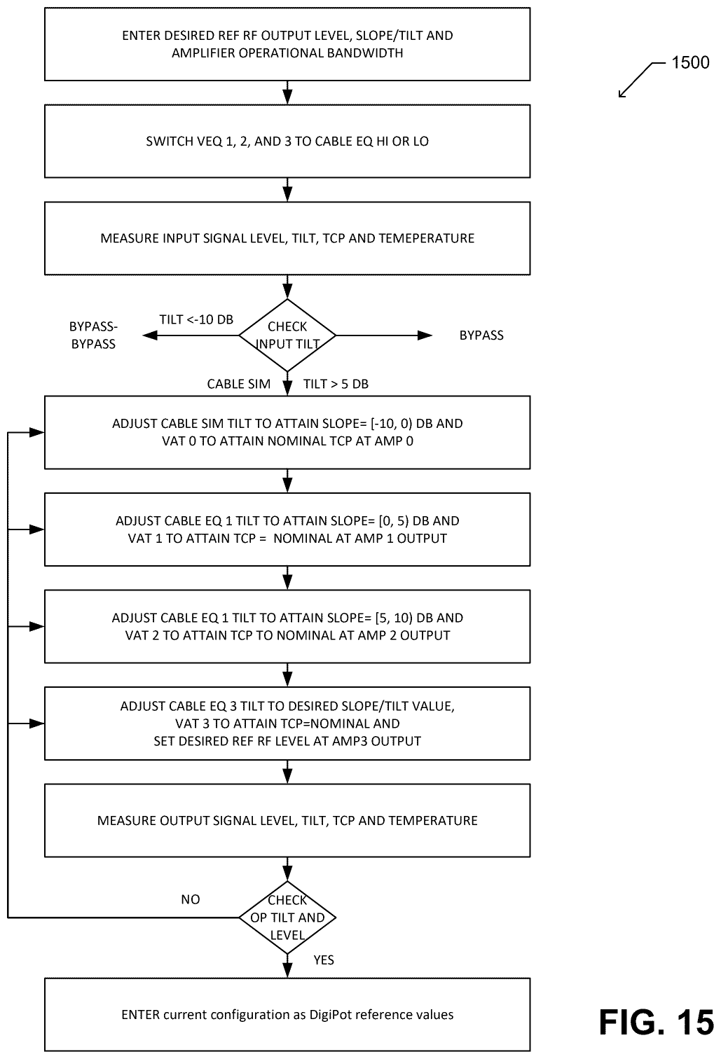

FIG. 15 depicts a flow chart of an exemplary process 1500 for setting up an amplifier station 1000. One or more steps of process 1500 may be performed by an operator, and one or more steps of process 1500 may be performed automatically by the station 1000. The process 1500 is in many places identical to process 1300, and identical steps will not be redundantly described. In the example of process 1500, the signal tilt at the input is measured at greater than 5 dBmV. Because the signal is entering the station 1000 with a high tilt, a cable-sim mode may be used to reduce the tilt so that high-frequency channels do not experience significant distortion from too much gain after passing through AMP 0. For example, VEQ configuration A or B may be used, of circuit topology 1 or 2, with pathway 1110 or 1116, respectively, used to send the signal through a CSIM module to reduce the tilt. VEQ 0 may be adjusted to attain a slope of −10 dB to 0 dB, and VAT 0 may be adjusted to attain nominal TCP (e.g., 54 to 63 dBmV) at the output of AMP 0. The remaining steps of process 1500 are identical to process 1300.

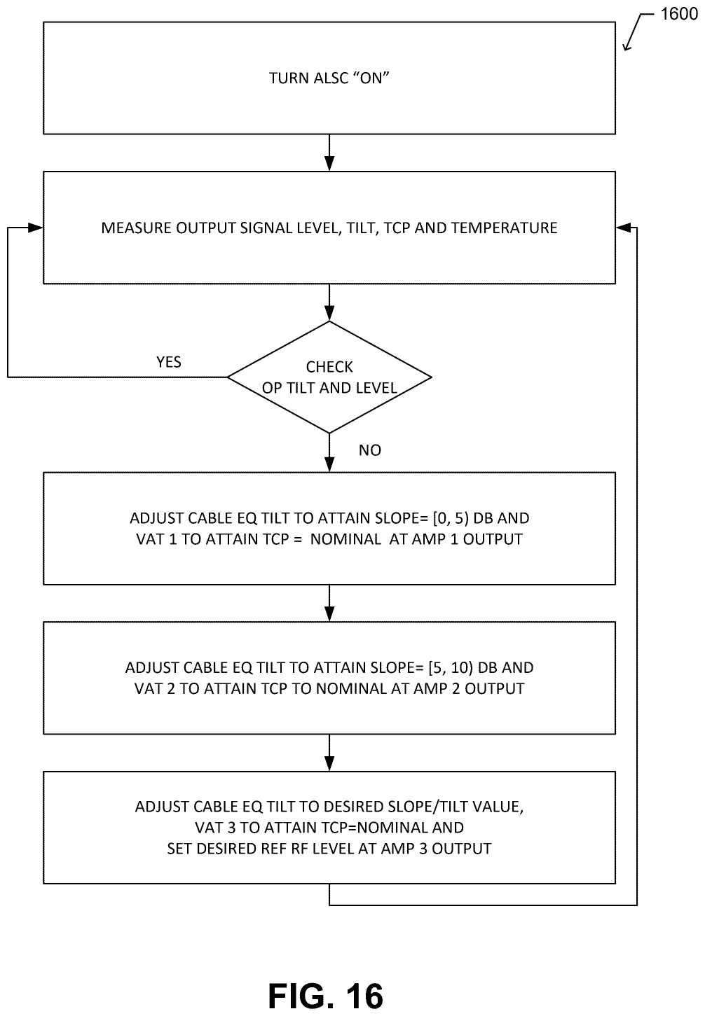

FIG. 16 depicts a flow chart of an exemplary process 1600 for maintaining signal characteristics (i.e., signal conditioning). Once the station 1000 has been set up, the signal maintenance process 1600 may be performed. The process 1600 begins with activating the ALSC (Automatic Level & Slope Control) mode, typically via a user interface connected to the micro-controller. The remaining steps of process 1600 may typically be performed automatically by the station 1000. With ALSC mode on, the signal levels, tilt, and TCP at the output (of AMP 3), and the temperature, are measured. The signal measurements are checked against the desired values, and if they match within an acceptable (pre-specified) tolerance, then no adjustments are made, and process 1600 repeats with measuring the outgoing signal. If the signal measurements (e.g., levels and tilt) are not within an acceptable tolerance of the desired values, then VATs and VEQs may be adjusted, similar to the adjustments made during setup process 1300, 1400, or 1500, until the signal measurements are within tolerance of the desired values. This allows the station 1000 to react to changes in, e.g., temperature, incoming cable length, signal bandwidth, or otherwise, and perform distributive ALSC to maintain signal performance.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein can be equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined by the following claims.

What is claimed is:

1. A broadband signal power amplifier comprising:
a signal input;
a signal-level meter (SLM);
a microcontroller communicatively coupled to the SLM;
a signal output;
a plurality of stages between the signal input and the signal output, wherein each stage comprises a variable attenuator module, a variable equalizer module, and an amplifier; and
wherein the SLM is configured to measure the total composite power (TCP) and the per-channel signal levels (PCLs) of the signal between the input and a first stage and between a last stage and the output, and provide the measurements to the microcontroller; and
wherein the microcontroller is configured to adjust the attenuation and equalization of the variable attenuator module and variable equalizer module of each stage such that the signal remains within a specified carrier to composite noise (CCN) range between the input and the output, and such that the signal has a desired TCP, PCLs, and tilt when passing through the output.

2. The broadband signal power amplifier of claim 1, wherein:
the first stage further comprises a first set of switches configured to switch a signal pathway between a pathway 1 and a pathway 2;
wherein:
pathway 1 includes the variable attenuator module and the variable equalizer module;
pathway 2 includes a bypass wire between the first set of switches; and
wherein the variable equalizer module comprises:
a second set of switches, configured to switch a circuit between a pathway 1A and a pathway 1B;
wherein pathway 1A comprises a cable-simulation module configured to reduce the tilt of a signal passing through pathway 1A; and
wherein the pathway 1B comprises a cable-equalizer module configured to increase the tilt of a signal passing through pathway 1B.

3. The broadband signal power amplifier of claim 2, wherein at least one of: (i) the cable-simulation module is a variable cable-simulation module; and (ii) the cable-equalizer module is a variable cable-equalizer module.

4. The broadband signal power amplifier of claim 2, wherein at least one of: (i) the cable-simulation module is a fixed cable-simulation module; and (ii) the cable-equalizer module is a fixed cable-equalizer module.

5. The broadband signal power amplifier of claim 1, wherein:
the first stage further comprises a first set of switches configured to switch a signal pathway between a pathway 1 and a pathway 2;
wherein:
pathway 1 includes the variable attenuator module and the variable equalizer module;
pathway 2 includes a bypass wire between the first set of switches; and
wherein the variable equalizer module comprises:
a second set of switches, configured to switch a circuit between a pathway 1A and a pathway 1B;
wherein pathway 1A comprises a cable-simulation module configured to reduce the tilt of a signal passing through pathway 1A; and
wherein the pathway 1B comprises a bypass wire between the second set of switches.

6. The broadband signal power amplifier of claim 5, wherein the cable-simulation module is a variable cable-simulation module.

7. The broadband signal power amplifier of claim 5, wherein the cable-simulation module is a fixed cable-simulation module.

8. The broadband signal power amplifier of claim 1, wherein:
the variable equalizer module of the first stage comprises:
a set of switches, configured to switch a circuit between a pathway 1 and a pathway 2;
wherein pathway 1 comprises a cable-simulation module configured to reduce the tilt of a signal passing through pathway 1; and
wherein the pathway 2 comprises a cable-equalizer module configured to increase the tilt of a signal passing through pathway 2.

9. The broadband signal power amplifier of claim 1, wherein:
the variable equalizer module of the first stage comprises:
a set of switches, configured to switch a circuit between a pathway 1 and a pathway 2;
wherein pathway 1 comprises a cable-simulation module configured to reduce the tilt of a signal passing through pathway 1; and
wherein the pathway 2 comprises a bypass wire between the set of switches.

10. The broadband signal power amplifier of claim 1, further comprising a plurality of digital potentiometers (DigiPots), wherein each DigiPot is disposed between (i) the variable attenuator module and variable equalizer module of each stage, and (ii) the microcontroller.

11. The broadband signal power amplifier of claim 1, wherein the amplifier of the first stage is a push-pull MMIC.

12. A broadband signal power amplifier comprising:
a first port;
a second port;
a plurality of at least four cascading stages between and coupled to the first port and the second port to form a path between the first port and the second port, each stage comprising, in the following order along the path between the first port to the second port:
a variable equalizer;
a variable attenuator;
an amplifier;
a signal-level meter (SLM) coupled to the first port and the second port, and programmed to measure attributes of an input signal received at the first port and an output signal to be launched from the second port, including:
input total composite power (TCP);
input tilt;
input per-channel signal levels (PCLs);
output total composite power (TCP);
output tilt; and
output PCLs;
a microcontroller communicatively coupled with the signal-level meter (SLM), the microcontroller programmed to:
(a) receive:
a desired output signal level; and
a desired output tilt;
the input total composite power (TCP);
the input tilt;
the input PCLs;
the output total composite power (TCP);
the output tilt; and
the output PCLs;
(b) control the variable attenuator of a first of the plurality of at least four cascading stages to attain nominal total composite power at the output of the amplifier of the first stage;
(c) control the variable equalizer of a second of the plurality of at least four cascading stages to attain tilt between about 0 dB and about 5 dB at the output of the amplifier of the first stage;
(d) control the variable attenuator of the second of the plurality of at least four cascading stages to attain nominal total composite power at the output of the amplifier of the second stage;
(e) control the variable equalizer of a third of the plurality of at least four cascading stages to attain tilt between about 5 dB and about 10 dB at the output of the amplifier of the third stage;
(f) control the variable attenuator of the third of the plurality of at least four cascading stages to attain nominal total composite power at the output of the amplifier of the third stage;
(g) control the variable attenuator of the fourth of the plurality of at least four cascading stages to attain the desired output TCP; and
(h) control the variable equalizer of the fourth of the plurality of at least four cascading stages to attain the desired output tilt.

13. The broadband signal power amplifier of claim 12, wherein:
the first stage further comprises a first set of switches configured to switch a signal pathway between a pathway 1 and a pathway 2;
wherein:
pathway 1 includes the variable attenuator and the variable equalizer;
pathway 2 includes a bypass wire between the first set of switches; and
wherein the variable equalizer comprises:
a second set of switches, configured to switch a circuit between a pathway 1A and a pathway 1B;
wherein pathway 1A comprises a cable-simulation module configured to reduce the tilt of a signal passing through pathway 1A; and
wherein the pathway 1B comprises a cable-equalizer module configured to increase the tilt of a signal passing through pathway 1B.

14. The broadband signal power amplifier of claim 12, wherein:
the first stage further comprises a first set of switches configured to switch a signal pathway between a pathway 1 and a pathway 2;
wherein:
pathway 1 includes the variable attenuator and the variable equalizer;
pathway 2 includes a bypass wire between the first set of switches; and
wherein the variable equalizer comprises:
a second set of switches, configured to switch a circuit between a pathway 1A and a pathway 1B;
wherein pathway 1A comprises a cable-simulation module configured to reduce the tilt of a signal passing through pathway 1A; and
wherein the pathway 1B comprises a bypass wire between the second set of switches.

15. The broadband signal power amplifier of claim 12, wherein:
the variable equalizer of the first stage comprises:
a set of switches, configured to switch a circuit between a pathway 1 and a pathway 2;
wherein pathway 1 comprises a cable-simulation module configured to reduce the tilt of a signal passing through pathway 1; and
wherein the pathway 2 comprises a cable-equalizer module configured to increase the tilt of a signal passing through pathway 2.

16. The broadband signal power amplifier of claim 12, wherein:
the variable equalizer of the first stage comprises:
a set of switches, configured to switch a circuit between a pathway 1 and a pathway 2;
wherein pathway 1 comprises a cable-simulation module configured to reduce the tilt of a signal passing through pathway 1; and
wherein the pathway 2 comprises a bypass wire between the set of switches.

17. The broadband signal power amplifier of claim 12, further comprising a plurality of digital potentiometers (DigiPots), wherein each DigiPot is disposed between (i) the variable attenuator and variable equalizer of each stage, and (ii) the microcontroller.

18. A variable signal equalizer (VEQ) module, comprising:
an input switch coupled to an output switch, the switches being configured to switch a circuit between a first pathway and a second pathway;
wherein the first pathway comprises a cable simulation module configured to reduce the tilt of a signal passing through the first pathway; and
wherein the second pathway comprises a cable equalizer module configured to increase the tilt of a signal passing through the second pathway.

19. A variable signal equalizer (VEQ) module, comprising:
an input switch coupled to an output switch, the switches being configured to switch a circuit between a first pathway and a second pathway;
wherein the first pathway comprises a cable simulation module configured to reduce the tilt of a signal passing through the first pathway; and
wherein the second pathway comprises a bypass wire between the input switch and the output switch.

20. A method of conditioning a broadband signal, performed on a broadband signal amplifier station that comprises:
a signal input;
a signal-level meter (SLM);
a microcontroller communicatively coupled to the SLM;
a signal output;
a signal pathway between the signal input and the signal output;
a plurality of stages along the signal pathway, wherein each stage comprises a variable attenuator module, a variable equalizer module, and an amplifier;
the method comprising:
receiving a broadband signal at the signal input;
measuring the per-channel signal levels (PCLs), the total composite power (TCP) and the tilt of the broadband signal via the signal-level meter prior to the first stage;
configuring the variable attenuator module and the variable equalizer module of the first stage such that the broadband signal will have nominal TCP at the output of the amplifier of the first stage while preventing any PCL from exceeding an upper threshold or falling below a lower threshold;
configuring the variable attenuator modules and the variable equalizer modules of each successive stage such that the broadband signal will have nominal TCP at the output of each amplifier, and such that the signal will have a predetermined tilt and TCP at the signal output; and
measuring the PCLs, the TCP, and the tilt of the broadband signal via the signal-level meter prior to the signal output.
